(19) United States
(12) Patent Application Publication
(10) Pub. No.: US 2017/0279339 A1
(43) Pub. Date: Sep. 28, 2017

(54) MOTOR-DRIVEN COMPRESSOR

(71) Applicant: KABUSHIKI KAISHA TOYOTA JIDOSHOKKI, Kariya-shi (JP)

(72) Inventors: Yusuke KINOSHITA, Kariya-shi (JP); Tatsuya KOIDE, Kariya-shi (JP); Junya YANO, Kariya-shi (JP)

(73) Assignee: KABUSHIKI KAISHA TOYOTA JIDOSHOKKI, Kariya-shi (JP)

(21) Appl. No.: 15/465,040

(22) Filed: Mar. 21, 2017

(30) Foreign Application Priority Data
Mar. 25, 2016 (JP) 2016-062126

(51) Int. Cl. H02K 11/33; F25B 31/02; H02K 5/22

(52) U.S. Cl. CPC H02K 11/33; H02K 5/225; F25B 31/026

(57) ABSTRACT

A connection structure of terminals according to the present invention includes an elastically-deformable first connector, to which a motor wire is electrically connected, an elastically-deformable second connector, to which a driving circuit wire is electrically connected, and a conductive portion, which electrically connects the first connector with the second connector. The first connector and the second connector are joined to the respective end surfaces of the conductive portion. The first connector is elastically deformed to hold the motor wire with its own restoring force. The second connector is elastically deformed to hold the driving circuit wire with its own restoring force.

### BACKGROUND OF THE INVENTION

The present invention relates to a motor-driven compressor.

For example, as disclosed in Japanese Laid-Open Patent Publication No. 2010-1882, a motor-driven compressor includes a compression unit, which compresses refrigerant, an electric motor, which drives the compression unit, a motor driving circuit, which drives the electric motor, and a housing. The housing has a motor compartment that accommodates the electric motor. The electric motor and the motor driving circuit are electrically connected to each other via conductive pins.

The conductive pins are provided with connectors, each of which has a body different from the conductive pin. The connectors electrically connect the conductive pins with motor wires, which are connected to the electric motor, and driving circuit wires, which are connected to the motor driving circuit. In some cases, the connectors hold the motor wires and the driving circuit wires with their elastic force. In this case, if the connectors are displaced, the connection between the electric motor and the motor driving circuit cannot be ensured.

### SUMMARY OF THE INVENTION

It is an objective of the present invention to provide a motor-driven compressor that maintains a good connection between the electric motor and the motor driving circuit.

To achieve the above objective, one aspect of the present invention is a motor-driven compressor including a housing, a compression unit that is accommodated in the housing and compresses refrigerant, an electric motor that drives the compression unit, a motor compartment that is formed in the housing and accommodates the electric motor, a cover that is attached to the housing, an accommodation chamber that is formed between the housing and the cover, a motor driving circuit that is accommodated in the accommodation chamber and drives the electric motor, a motor wire that is electrically connected to the electric motor, a driving circuit wire that is electrically connected to the motor driving circuit, and a conductive portion that has a first end, to which the motor wire is electrically connected, and a second end, to which the driving circuit wire is electrically connected. The conductive portion electrically connects the motor wire with the driving circuit wire. At least one of the first end and the second end of the conductive portion is attached to a connector that has an elastic portion that is deformable elastically and a joining portion that is joined to an end surface of the conductive portion. By being elastically deformed, the connector holds, with its own restoring force, the wire that is electrically connected to the end of the conductive portion to which the connector is attached.

### BRIEF DESCRIPTION OF THE DRAWINGS

FIG. 1 is a cross-sectional side view of a motor-driven compressor according to one embodiment of the present invention.

FIG. 2A is an enlarged cross-sectional view illustrating a part of the motor-driven compressor.

FIG. 2B is an enlarged cross-sectional view illustrating a part of a female terminal and a conductive portion.

FIG. 3 is an exploded cross-sectional view illustrating a part of the motor-driven compressor.

FIG. 4A is a plan view of a connector.

FIG. 4B is a cross-sectional view taken along line 4B-4B of FIG. 4A.

FIG. 4C is a cross-sectional view taken along line 4C-4C of FIG. 4A.

FIG. 5 is a diagram illustrating the connection between the conductive member and the connector.

### DETAILED DESCRIPTION OF THE PREFERRED EMBODIMENTS

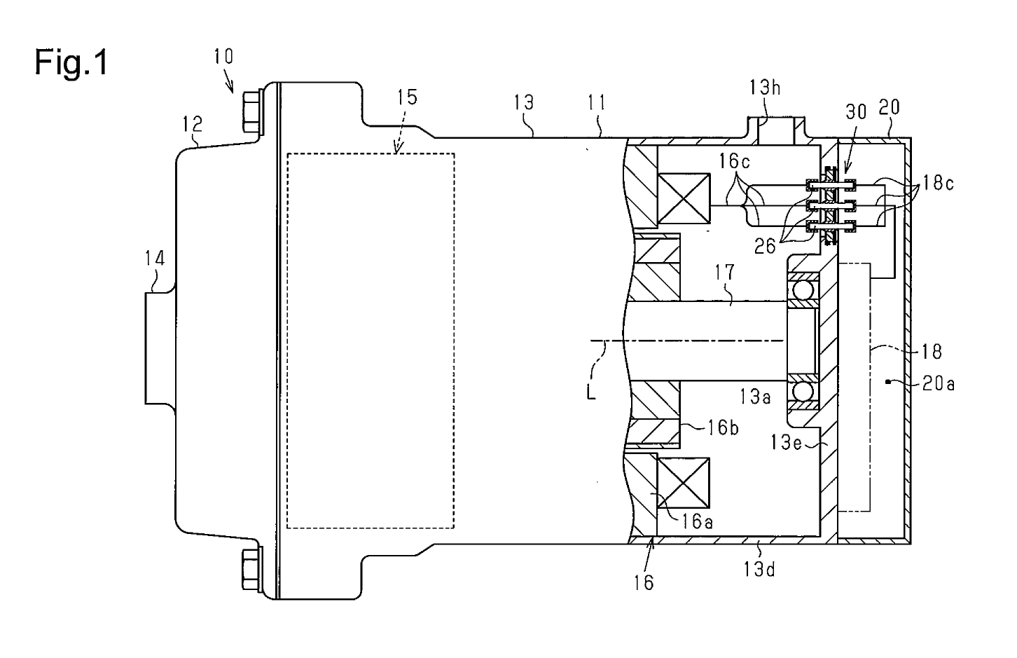

A motor-driven compressor according to one embodiment of the present invention will now be described with reference to FIGS. 1 to 5. The motor-driven compressor is used in a vehicle air-conditioner.

As shown in FIG. 1, the motor-driven compressor 10 includes a housing 11 that includes a discharge housing member 12 and a suction housing member 13. The suction housing member 13 includes an end wall 13e and a side wall 13d that is provided on the periphery of the end wall 13e. A suction port 13h is formed in the side wall 13d. The suction port 13h is connected to an external refrigerant circuit (not shown). A discharge port 14 is formed on the discharge housing member 12. The discharge port 14 is connected to the external refrigerant circuit.

The motor-driven compressor 10 includes a compression unit 15 (indicated by a broken line in FIG. 1), which is accommodated in the suction housing member 13 and compresses refrigerant, and an electric motor 16, which drives the compression unit 15. A motor compartment 13a, which accommodates an electric motor 16, is formed in the suction housing member 13. The suction housing member 13 rotationally supports a rotary shaft 17. The compression unit 15 includes a fixed scroll, which is fixed to the suction housing member 13, and a movable scroll, which is arranged to be opposed to the fixed scroll (the drawings of the fixed scroll and the movable scroll are omitted). The electric motor 16 includes a stator 16a, which is fixed to the inner circumferential surface of the suction housing member 13, and a rotor 16b, which is attached to the rotary shaft 17.

A cover 20 is attached to the outer surface of the end wall 13e, which is on the opposite side from the discharge housing member 12. The discharge housing member 12, the suction housing member 13, and the cover 20 each have a tubular shape with a closed bottom and are made of a metal material, e.g., aluminum or the like. An accommodation chamber 20a is formed between the end wall 13e and the cover 20. The accommodation chamber 20a accommodates a motor driving circuit 18, which drives the electric motor 16. The motor driving circuit 18 includes a circuit board, on which a driving control circuit (an inverter circuit) of the electric motor 16 is provided, and electric parts such as switching devices and capacitors. The compression unit 15, the electric motor 16, and the motor driving circuit 18 are arranged in line in this order along the axis L of the rotary shaft 17. The end wall 13e functions as a partition that divides the motor compartment 13a from the accommodation chamber 20a.

The motor-driven compressor 10 includes three motor wires 16c, which are electrically connected to the electric motor 16. The respective motor wires 16c are drawn from the U phase coil, the V phase coil, and the W phase coil of the electric motor 16. The motor-driven compressor 10 includes three driving circuit wires 18c, which are electrically connected to the motor driving circuit 18.

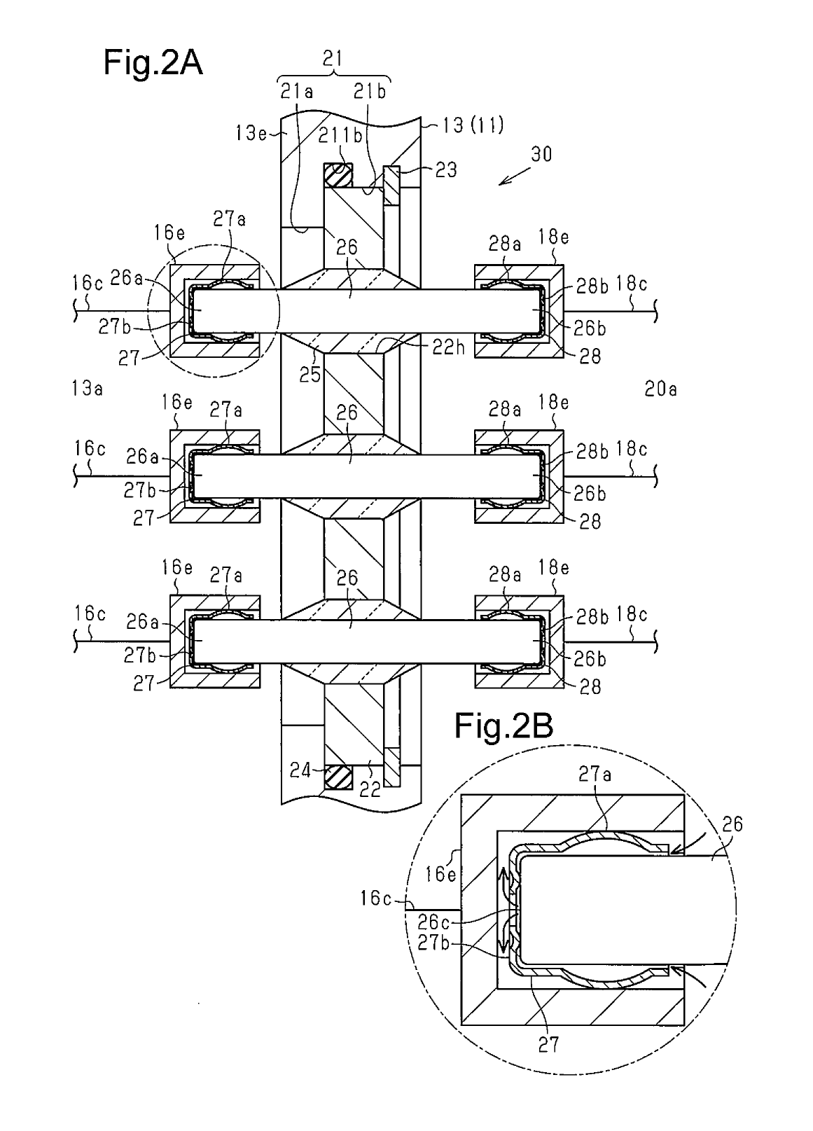

As shown in FIG. 2A, the end wall 13e includes a through-hole 21. The through-hole 21 includes a small diameter hole 21a and a large diameter hole 21b. The diameter of the large diameter hole 21b is larger than the diameter of the small diameter hole 21a. The small diameter hole 21a and the large diameter hole 21b are continuous with each other in the thickness direction of the end wall 13e. The small diameter hole 21a faces the motor compartment 13a, and the large diameter hole 21b faces the accommodation chamber 20a. Thus, the through-hole 21 is shaped like a step. A support member 22 is arranged in the large diameter hole 21b. The support member 22 is fitted to the large diameter hole 21b, and a snap ring 23 holds the support member 22 such that the support member 22 does not fall off the large diameter hole 21b. The support member 22 may be fixed to the end wall 13e, for example, with a bolt.

An annular sealing member 24 is provided between the outer circumferential surface of the support member 22 and the inner wall of the large diameter hole 21b. The inner wall of the large diameter hole 21b includes a seal accommodation chamber 211b, which accommodates the sealing member 24. The seal accommodation chamber 211b is formed by enlarging a portion of the inner circumferential surface of the inner wall of the large diameter hole 21b radially outward to be broader than the other portion. By arranging the sealing member 24 between the support member 22 and the inner wall of the large diameter hole 21b (through-hole 21), the sealing of the sealing member 24 prevents the motor compartment 13a and the accommodation chamber 20a from communicating with each other. The support member 22 is a part of an airtight terminal portion 30, which will be described later. Thus, the sealing member 24 is arranged between the airtight terminal portion 30 and the inner wall of the through-hole 21. For example, the sealing member 24 may be replaced by a gasket or the like as long as the gasket or the like allows sealing to prevent the motor compartment 13a and the accommodation chamber 20a from communicating with each other by being arranged between the inner wall of the through-hole 21 and the airtight terminal portion 30.

The support member 22 includes three through-holes 22h. A columnar conductive portion 26 is inserted in each through-hole 22h. The conductive portion 26 is a pin-shaped member. An adhesive member 25 is provided between the inner wall of the through-hole 22h and the outer circumferential surface of the conductive portion 26. The conductive portion 26 is fixed to the support member 22 by the adhesive member 25. The adhesive member 25 is made of glass. However, the glass may be replaced by, e.g., an adhesive agent, rubber, or the like as long as the adhesive agent, rubber, or the like allows sealing to prevent the motor compartment 13a and the accommodation chamber 20a from communicating with each other by fixing the conductive portion 26 to the support member 22 and being arranged between the inner wall of the through-hole 22h and the outer circumferential surface of the conductive portion 26. The adhesive member 25 needs to be insulated if the support member 22 is made of metal. In the motor-driven compressor 10, the end wall 13e divides the motor compartment 13a from the accommodation chamber 20a. The conductive portion 26 includes a first end 26a extending in the motor compartment 13a and a second end 26b extending in the accommodation chamber 20a.

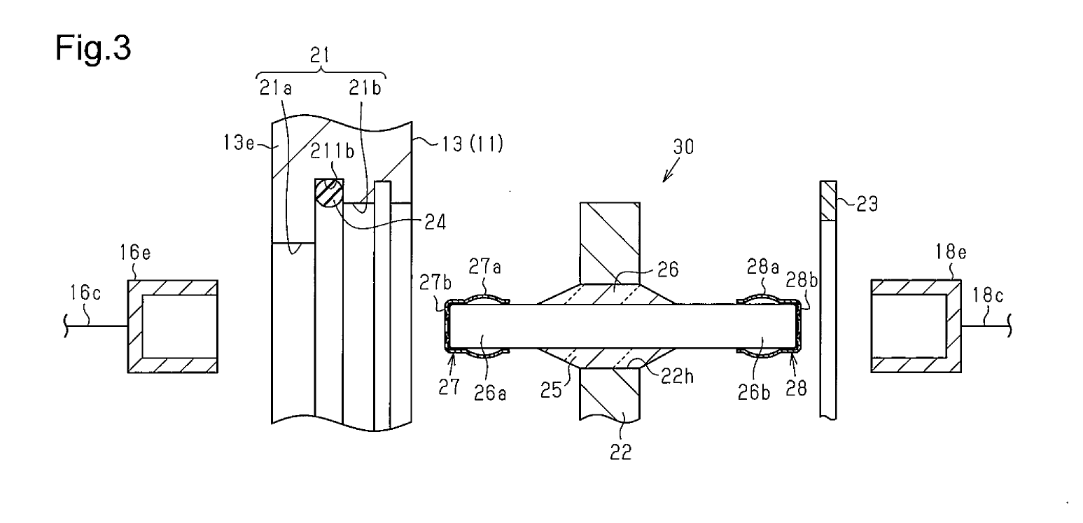

As shown FIGS. 2A and 3, the first end 26a of each conductive portion 26 is attached to a first connector 27, to which one of the motor wires 16c is electrically connected. The first end 26a of the conductive portion 26 is inserted into the first connector 27. This attaches the first connector 27 to the first end 26a of the conductive portion 26 and electrically connects the first connector 27 with the conductive portion 26. The first connector 27 has a body different from the conductive portion 26. The first connector 27 is a tubular member with a closed bottom, which is attached to the first end 26a of the conductive portion 26 to cover the first end 26a of the conductive portion 26. The first connector 27 has a through-hole at the bottom.

The second end 26b of each conductive portion 26 is attached to a second connector 28, to which one of the driving circuit wires 18c is electrically connected. The second end 26b of the conductive portion 26 is inserted into the second connector 28. This attaches the second connector 28 to the second end 26b of the conductive portion 26 and electrically connects the second connector 28 with the conductive portion 26. The second connector 28 has a body different from the conductive portion 26. The second connector 28 is a tubular member with a closed bottom, which is attached to the second end 26b of the conductive portion 26 to cover the second end 26b of the conductive portion 26. The second connector 28 has a through-hole at the bottom.

As described above, the conductive portion 26 is arranged between the first connector 27 and the second connector 28 and electrically connects the first connector 27 with the second connector 28. The support member 22, the conductive portions 26, the first connectors 27, the second connectors 28, and the adhesive members 25 form the airtight terminal portion 30.

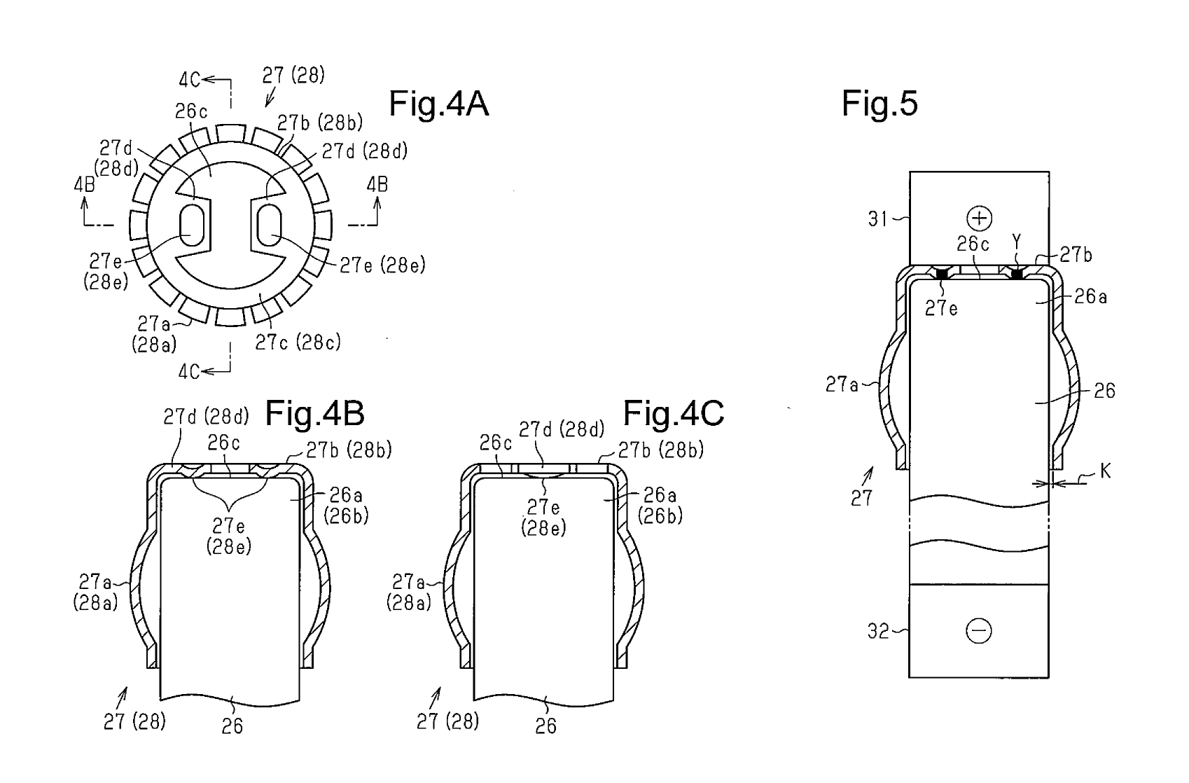

With reference to FIGS. 4A to 4C and 5, the configuration of each first connector 27 will now be described. Each second connector 28 has the same configuration as the first connector 27. Thus, in FIGS. 4A to 4C, the reference numeral of each component of the second connector 28 is added in parentheses.

As shown in FIGS. 4A to 4C, the first connector 27 includes an elastic portion 27a that is deformable elastically and a joining portion 27b. The joining portion 27b is joined to an end surface of the corresponding conductive portion 26 in a state in which the first connector 27 is attached to the conductive portion 26. The joining portion 27b has an annular shape in a planar view. The joining portion 27b includes an annular portion 27c, which is flat-shaped, and two tongue pieces 27d. The elastic portion 27a is arranged on the periphery of the annular portion 27c and integrated with the annular portion 27c. Since the elastic portion 27a has a curved portion swelling outward, the elastic portion 27a is capable of elastically being deformed inward. The two tongue pieces 27d project from the inner circumferential edge of the annular portion 27c toward the center of the annular portion 27c (radially inward). Each tongue piece 27d includes a projection 27e, which projects in the longitudinal direction of the elastic portion 27a. In other words, as shown in FIGS. 4B and 4C, in a state in which the first connector 27 is attached to the first end 26a of the conductive portion 26, the projection 27e projects toward the end surface 26c of the first end 26a. The end surface 26c of the first end 26a is a surface crossing the axis of the conductive portion 26.

As shown in FIG. 5, the first connector 27 is joined to the end surface 26c of the conductive portion 26 by resistance welding. The resistance welding is a method in which objects to be connected are welded by being sandwiched by positive and negative welding electrodes 31 and 32 in a pair. When the first connector 27 covers the first end 26a of the conductive portion 26, the projections 27e of the joining portion 27b contact the end surface 26c of the conductive portion 26. Thus, joule heat is generated in portions in which the end surface 26c of the conductive portion 26 contacts the projections 27e of the joining portion 27b between the conductive portion 26 and the first connector 27, which are sandwiched by the positive and negative welding electrodes 31 and 32 in the pair. This melts the contact portions, which congeal into nuggets Y. A portion of the joining portion 27b of the first connector 27 is welded to the end surface 26c of the conductive portion 26. The nuggets Y, which are joints between the end surface 26c of the conductive portion 26 and the joining portion 27b, exist only on a part of the end surface 26c of the conductive portion 26. In other words, the conductive portion 26 and the first connector 27 are joined to each other only with the joints on the end surface 26c of the conductive portion 26. The outer circumferential surface of the conductive portion 26, which faces the elastic portion 27a, has no joint.

In a state in which the first connector 27 is joined to the conductive portion 26, the inner surface of the elastic portion 27a faces the outer circumferential surface of the conductive portion 26, and the inner surface of the joining portion 27b faces the end surface 26c of the conductive portion 26. In the parts except the projections 27e, the inner surface of the first connector 27 has surface contact with neither the outer circumferential surface nor the end surface 26c of the conductive portion 26. For example, as shown in FIG. 5, a small clearance K exists between the inner surface of the first connector 27 and the outer circumferential surface and the end surface 26c of the conductive portion 26.

As shown in FIGS. 4A to 4C, the second connector 28 includes an elastic portion 28a, a joining portion 28b, an annular portion 28c, tongue pieces 28d, and projections 28e, which correspond to the elastic portion 27a, the joining portion 27b, the annular portion 27c, the tongue pieces 27d, and the projections 27e of the first connector 27, respectively. In a similar way to the first connector 27, the second connector 28 is joined to the end surface 26c of the second end 26b of the conductive portion 26 by resistance welding. The end surface 26c of the second end 26b is a surface crossing the axis of the conductive portion 26.

Returning to the description of FIGS. 2A and 3, a recessed female terminal 16e is provided at the end of each motor wire 16c that is on the opposite side from the electric motor 16. The female terminal 16e fits onto one of the first connectors 27. Specifically, when the first connector 27 is inserted into the female terminal 16e, the elastic portion 27a is elastically deformed inward by being pressed by the inner wall of the female terminal 16e. The elastic portion 27a holds the female terminal 16e by being pressed against the inner wall of the female terminal 16e with its own restoring force. Thus, the female terminal 16e fits onto the first connector 27 so that the motor wire 16c is electrically connected to the first connector 27.

A recessed female terminal 18e is provided at the end of each driving circuit wire 18c that is on the opposite side from the motor driving circuit 18. The female terminal 18e fits onto one of the second connectors 28. Specifically, when the second connector 28 is inserted into the female terminal 18e, the elastic portion 28a is elastically deformed inward by being pressed by the inner wall of the female terminal 18e. The elastic portion 28a holds the female terminal 18e by being pressed against the inner wall of the female terminal 18e with its own restoring force. Thus, the female terminal 18e fits onto the second connector 28 so that the driving circuit wire 18c is electrically connected to the second connector 28.

As described above, the first connector 27 is connected to the motor wire 16c by being inserted into the female terminal 16e of the motor wire 16c. The second connector 28 is connected to the driving circuit wire 18c by being inserted into the female terminal 18e of the driving circuit wire 18c. In other words, the connection manner between the first connector 27 and the motor wire 16c is the same as the connection manner between the second connector 28 and the driving circuit wire 18c.

Operational advantages of the motor-driven compressor 10 will now be described.

(1) Each first connector 27 holds one of the motor wires 16c with its own restoring force by being elastically deformed. Each second connector 28 holds one of the driving circuit wires 18c with its own restoring force by being elastically deformed. Thus, the motor wire 16c and the driving circuit wire 18c are connected to the corresponding conductive portion 26 via the first connector 27 and the second connector 28, respectively.

(2) The two opposite ends of each conductive portion 26 include the end surfaces 26c, which are joined to one of the first connectors 27 and one of the second connectors 28, respectively. This restricts the first and second connectors 27 and 28 from moving relative to the conductive portion 26 in the axial direction of the conductive portion 26. Thus, for example, when the motor-driven compressor 10 is mounted to a vehicle, it is possible to limit movements of the first connector 27 and the second connector 28 caused by vibrations that are generated as the vehicle travels. In other words, it is possible to restrict the female terminals 16e and 18e from falling off and to restrict the first connector 27 and the second connector 28 from falling off the conductive portion 26 due to movements of the first connector 27 and the second connector 28. Therefore, the connection state between the electric motor 16 and the motor driving circuit 18 is well maintained even when the motor-driven compressor 10 is mounted to a vehicle that vibrates hard.

(3) Each conductive portion 26, to which one of the first connectors 27 and one of the second connectors 28 are attached, is attached to the corresponding female terminals 16e and 18e by being inserted in the axial direction of the conductive portion 26. In this case, if the first connector 27 and the second connector 28 are connected to the end surfaces 26c of the conductive portion 26, the joints do not become an obstructive factor in attaching the conductive portion 26 to the female terminals 16e and 18e. However, if the first connector 27 and the second connector 28 are connected to the outer circumferential surface of the conductive portion 26, the joints are formed on the outer circumferential surface of the conductive portion 26. If the first and second connectors 27 and 28 are welded to the conductive portion 26, the joints have rough surfaces. This becomes an obstructive factor in inserting the conductive portion 26 into the female terminals 16e and 18e. Therefore, the connection structure according to the present embodiment improves the mounting performance.

(4) Each first connector 27 and each second connector 28 are restricted from moving relative to the corresponding conductive portion 26 in the axial direction of the conductive portion 26. Thus, when the conductive portion 26 is mounted to the female terminals 16e and 18e, the first connector 27 and the second connector 28 do not move so that poor connection is limited. In addition, the conductive portion 26 does not need to include a member for restricting movement of the first connector 27 and the second connector 28. Thus, the conductive portion 26 is allowed to have a simple pin shape.

(5) Welding is used to connect each conductive portion 26 with one of the first connectors 27 and one of the second connectors 28. Furthermore, the welding is performed on the end surfaces 26c of the conductive portion 26, which are flat surfaces. This improves productivity and welding quality since the electric current flows in one direction at resistance welding. Further, the nuggets Y are formed on the end surfaces 26c of the conductive portion 26. Thus, it is possible to mount the conductive portion 26 to the female terminals 16e and 18e such that the conductive portion 26 does not obstruct the female terminals 16e and 18e, and the necessary strength of welding is reduced. In other words, as described in the above items (2) and (4), the strength of welding may be set to such a degree at which movement of the first connector 27 and the second connector 28 is restricted. This improves the productivity.

(6) In a state in which the first end 26a of each conductive portion 26 is attached to one of the first connectors 27, the projections 27e contact the corresponding end surface 26c of the conductive portion 26. In a state in which the second end 26b of the conductive portion 26 is attached to one of the second connectors 28, the projections 28e contact the corresponding end surface 26c of the conductive portion 26. Thus, when resistance welding is performed, the connection portion between the conductive portion 26 and the first connector 27 and the connection portion between the conductive portion 26 and the second connector 28 are stably obtained so that the welding quality is improved.

(7) The joint between the conductive portion 26 and the first connector 27 exists only on a part of the corresponding end surface 26c of the conductive portion 26. The joint between the conductive portion 26 and the second connector 28 exists only on a part of the corresponding end surface 26c of the conductive portion 26. Thus, a clearance K is formed between the inner surface of the first connector 27 and the end surface 26c of the conductive portion 26, and a clearance K is formed between the inner surface of the second connector 28 and the end surface 26c of the conductive portion 26. Thus, as indicated by arrows in FIG. 2B, flow passages, through which refrigerant in the motor-driven compressor 10 passes, are formed between the conductive portion 26 and the first connector 27 and between the conductive portion 26 and the second connector 28. In other words, the refrigerant enters through the gap between the conductive portion 26 and the end of the elastic portion 27a, 28a that is on the opposite side from the joining portion 27b, 28b. The refrigerant then passes between the conductive portion 26 and the elastic portion 27a, 28a and passes between the conductive portion 26 and the annular portion 27c, 28c. After that, the refrigerant flows out to the outside through the first connector 27 or the second connector 28. This provides the cooling effect of the conductive portion 26 so that the wire can handle high electric currents.

The above-illustrated embodiment may be modified in the following forms.

Only one of the first end 26a and the second end 26b of the conductive portion 26 may be attached to the first connector 27 or the second connector 28. In other words, the structure of a connector attached to one of the two opposite ends of the conductive portion 26 may be the same as the structure according to the present embodiment, and the structure of a connector attached to the other end may be another structure. Alternatively, the connection between the other end of the conductive portion 26 and the wire does not necessarily need to use a connector.

Other than welding, adhesion using a conductive adhesive or soldering may be used to connect the conductive portion 26 with the first connector 27 and the second connector 28.

The number of locations at which each end surface 26c of the conductive portion 26 is connected to the first connector 27 or the second connector 28 is not limited to two and may be one or more than two.

The projections 27e may be omitted from the joining portion 27b of the first connector 27. The projections 28e may be omitted from the joining portion 28b of the second connector 28. The joining portions 27b and 28b may be formed by flat surfaces.

The cross-sectional surface of the conductive portion 26 may be elliptical or polygonal. In addition, the first connector 27 and the second connector 28 may have any shape as long as the first connector 27 and the second connector 28 have the elastic portions 27a and 28a and the joining portions 27b and 28b.

The conductive portion 26, the first connector 27, and the second connector 28 do not necessarily need to be used to configure the airtight terminal portion 30. In other words, the first connector 27 and the second connector 28 may be applied to a connection structure without airtightness.

The number of motor wires 16c is not limited to three. In this case, the number of conductive portions 26 and the number of driving circuit wires 18c are the same as the number of the motor wires 16c.

An accommodation chamber 20a, which accommodates the motor driving circuit 18, may be formed between the side wall 13d of the suction housing member 13 and the cover 20 by fixing the cover 20 to the side wall 13d of the suction housing member 13. In this case, the circumferential wall of the suction housing member 13 functions as a partition wall that divides the motor compartment 13a from the accommodation chamber 20a.

The compression unit 15, the electric motor 16, and the motor driving circuit 18 are arranged in line in this order along the axis L of the rotary shaft 17. However, they may be arranged in line in the order of the electric motor 16, the compression unit 15, and the motor driving circuit 18.

The compression unit 15 is not limited to a type configured by a fixed scroll and a movable scroll. For example, a piston type and a vane type may be used.

The motor-driven compressor 10 may be used for other air-conditioners than the vehicle air-conditioner.

1. A motor-driven compressor comprising:
a housing;
a compression unit that is accommodated in the housing and compresses refrigerant;
an electric motor that drives the compression unit;
a motor compartment that is formed in the housing and accommodates the electric motor;
a cover that is attached to the housing;
an accommodation chamber that is formed between the housing and the cover;
a motor driving circuit that is accommodated in the accommodation chamber and drives the electric motor;
a motor wire that is electrically connected to the electric motor;
a driving circuit wire that is electrically connected to the motor driving circuit; and
a conductive portion that has a first end, to which the motor wire is electrically connected, and a second end, to which the driving circuit wire is electrically connected, wherein the conductive portion electrically connects the motor wire with the driving circuit wire, wherein
at least one of the first end and the second end of the conductive portion is attached to a connector that has an elastic portion that is deformable elastically and a joining portion that is joined to an end surface of the conductive portion, and
by being elastically deformed, the connector holds, with its own restoring force, the wire that is electrically connected to the end of the conductive portion to which the connector is attached.

2. The motor-driven compressor according to claim 1, wherein
the joining portion has a projection that projects toward an end surface of the conductive portion, and
the projection is joined to the end surface of the conductive portion.

3. The motor-driven compressor according to claim 1, wherein
a joint between the joining portion and an end surface of the conductive portion exists on a part of the end surface of the conductive portion.
